(19) United States
(12) Patent Application Publication
(10) Pub. No.: US 2019/0113873 A1
(43) Pub. Date: Apr. 18, 2019

(54) POST-PROCESSING DEVICE AND IMAGE FORMING SYSTEM

(71) Applicant: Konica Minolta, Inc., Tokyo (JP)

(72) Inventor: Hiroyuki WAKABAYASHI, Tokyo (JP)

(21) Appl. No.: 16/120,818

(22) Filed: Sep. 4, 2018

(30) Foreign Application Priority Data
Oct. 16, 2017 (JP) 2017-200312

(51) Int. Cl. G03G 15/00

(52) U.S. Cl. CPC G03G 15/6523; G03G 2215/00814

(57) ABSTRACT

A post-processing device includes: a cutter that performs cutting processing for dividing a printed sheet into a plurality of pieces; and a hardware processor that determines an overlapping region where a content of a recovery-printed sheet on which recovery printing has been performed due to an error which causes the cutting processing to be stopped during the cutting processing by the cutter is overlapped with a content of a printed matter obtained by the cutting processing before the error occurs, and makes the cutter cut the overlapping region of the recovery-printed sheet into pieces larger than the printed matter.

The entire disclosure of Japanese patent Application No. 2017-200312, filed on Oct. 16, 2017, is incorporated herein by reference in its entirety.

### BACKGROUND

### Technological Field

The present invention relates to a post-processing device and an image forming system.

### Description of the Related Art

There is an image forming system including an image forming device which forms an image on a sheet and a post-processing device which performs post processing on the sheet on which the image has been formed by the image forming device. The image forming device and the post-processing device respectively perform image forming processing and post processing according to setting values of various items regarding the image forming processing and the post processing.

The post processing performed by the post-processing device is, for example, cutting processing for creating printed matters (for example, business card, card, and postcard) by dividing a single sheet into a plurality of pieces. The cutting processing is performed by a cutter provided in the post-processing device (refer to FIGS. 1A and 1B). The printed matter which has been created by cutting the sheet by the cutter is normally discharged to a stacker or a sheet discharge tray provided in the post-processing device. Chips and the like generated at the time of cutting the sheet by the cutter are dropped into a trash box provided in the post-processing device.

Here, an outline of a peripheral configuration of the cutter included in the post-processing device will be described.

FIGS. 1A and 1B are explanatory diagrams of an example of the cutter. FIG. 1A illustrates an example in which a downstream end of a sheet S is cut as chips, and FIG. 1B illustrates an example in which an upstream end of the sheet S is cut as chips. Here, an exemplary structure of a guillotine cutter 101 will be described as an example of the cutter. In the following description, when it is assumed that a conveying direction of the sheet S be a direction from right to left in FIG. 1A, the right side in FIG. 1A is referred to as “upstream”, and the left side is referred to as “downstream”.

The sheet S is conveyed from the upstream to the downstream through a conveyance path 100. At this time, the sheet S is held by a pair of upstream conveyance rollers 102 arranged on the upstream side of the conveyance path 100 and a pair of downstream conveyance rollers 103 arranged on the downstream side of the conveyance path 100. The conveyance of the sheet S is temporarily stopped in the middle of the conveyance path 100, that is, between the upstream conveyance rollers 102 and the downstream conveyance rollers 103, and the guillotine cutter 101 cuts the sheet S.

The guillotine cutter 101 includes an upper cutter 101a arranged on the upper side of the conveyance path 100 and a lower cutter 101b arranged on the lower side of the conveyance path 100. The upper cutter 101a moves downward and the lower cutter 101b moves upward so that an end of the sheet S is cut at a cutting position 101c between blades of the upper cutter 101a and the lower cutter 101b. Since the cut end of the sheet S is unnecessary chips, the chips are dropped into a trash box 104 arranged below the upper cutter 101a and the lower cutter 101b.

There is a case where the cutting processing is stopped due to a jam and the like which occur when the guillotine cutter 101 is cutting the single sheet S. In this case, the sheet S being cut is removed from the post-processing device as unnecessary jammed paper. Thereafter, the image forming device reprints a content printed on the sheet S removed as the jammed paper on a new sheet S (this processing is referred to as “recovery printing”), and the post-processing device performs the cutting processing on the recovery-printed sheet S (referred to as “recovery sheet” below). To perform the recovery printing and the post-processing, for example, a technique disclosed in JP 2015-105973 A has been known.

JP 2015-105973 A discloses a technique which determines whether a cut part has been output before the jam when the jam occurs at the time of cutting and the recovery printing is performed and discharges a sheet on which the recovery printing has been performed to a discharge destination different from that of the preceding sheet in a case where a recovery-printed region is overlapped with the region output before the occurrence of the jam.

When the jam occurs as described above, after the jammed paper has been removed from the post-processing device, the recovery printing is performed, and the cutting processing is performed on the recovery sheet. However, there is a case where a part of the jammed paper has been already discharged as a printed matter. In this case, the recovery sheet includes an overlapping region in which a content same as the printed matter obtained before the recovery printing is printed. Therefore, the guillotine cutter 101 finely cuts the overlapping region, and the cut overlapping region is dropped into the trash box 104 as chips.

Here, as illustrated in FIGS. 1A and 1B, it is assumed that a length from the cutting position 101c to a position of the central axis of the upstream conveyance roller 102 be L1 and that a length from the cutting position 101c to a position of the central axis of the downstream conveyance roller 103 be L2. It is necessary for the upstream conveyance roller 102 and the downstream conveyance roller 103 to sandwich and hold the printed matter to be cut by the guillotine cutter 101. Therefore, the upstream conveyance roller 102 and the downstream conveyance roller 103 are arranged so that the length L1+L2 between the upstream conveyance roller 102 and the downstream conveyance roller 103 is shorter than the length of the printed matter in the conveying direction.

On the other hand, to drop the chips obtained by cutting the overlapping region of the recovery sheet by the guillotine cutter 101 into the trash box 104, it is necessary to cut the overlapping region into pieces having the length in the conveying direction equal to or shorter than a predetermined width (normally, about 10 mm). Since both lengths L1 and L2 are shorter than the length of the printed matter in the conveying direction, if the overlapping region is not cut into pieces having the size equal to or shorter than the predetermined width, chips are stuck between the guillotine cutter 101 and the upstream conveyance roller 102 or the downstream conveyance roller 103 and cannot be dropped into the trash box 104. Therefore, it is necessary to cut the overlapping region so that the width of the chip in the conveying direction is sufficiently shorter than the length of the printed matter. However, if the number of times of cutting increases, the recovery sheets are stopped at the guillotine cutter 101 depending on the number of times of cutting. Therefore, productivity of the post-processing device (for example, the number of products of printed matters per hour) largely deteriorates.

For example, when the printed matter is a business card, the recovery sheet is often conveyed so that a longitudinal direction of the business card is arranged to be parallel to the conveying direction. Here, a size of a general business card is 91 mm×55 mm. Therefore, to cut the recovery sheet into pieces having the width equal to or shorter than the predetermined width (10 mm), based on 91±10=9.1, the guillotine cutter 101 has to cut the sheet at least nine times. When the guillotine cutter 101 is cutting the sheet, the other processing cannot be performed by the post-processing device, and the productivity of the post-processing device is deteriorated.

Therefore, it is considered that the number of times of cutting can be reduced if the overlapping region is output as a printed matter. However, in a case where the printed matters are not allowed to be duplicated (for example, variable printed matter on which address on postcard is printed), the overlapping region cannot be originally output as a printed matter.

JP 2015-105973 A only discloses that the sheet is discharged to the discharge destination different from the preceding sheet in a case where the recovery-printed region is overlapped with the region output before the occurrence of the jam. A user needs to confirm at least two discharge destinations and confirm parts overlapped with the preceding sheet. In this way, since the confirmation by the user takes time and labor, the productivity of the post-processing device is deteriorated.

### SUMMARY

The present invention has been made in view of such a situation, and an object of the present invention is to prevent deterioration in productivity when a recovery-printed sheet is cut to obtain a printed matter.

To achieve the abovementioned object, according to an aspect of the present invention, a post-processing device reflecting one aspect of the present invention comprises: a cutter that performs cutting processing for dividing a printed sheet into a plurality of pieces; and a hardware processor that determines an overlapping region where a content of a recovery-printed sheet on which recovery printing has been performed due to an error which causes the cutting processing to be stopped during the cutting processing by the cutter is overlapped with a content of a printed matter obtained by the cutting processing before the error occurs, and makes the cutter cut the overlapping region of the recovery-printed sheet into pieces larger than the printed matter.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A and 1B are schematic diagrams of an exemplary cutter according to an embodiment of the present invention;

FIG. 2 is a schematic diagram of an exemplary overall configuration of an image forming system according to an embodiment of the present invention;

FIG. 3 is a schematic diagram of an exemplary inner configuration of a post-processing device according to an embodiment of the present invention;

FIGS. 4A to 4D are explanatory diagrams of a state where a sheet conveyed to the post-processing device according to an embodiment of the present invention is cut;

FIGS. 5A and 5B are explanatory diagrams of an exemplary configuration of a slitter according to an embodiment of the present invention;

FIG. 6 is a schematic diagram of an exemplary hardware configuration of an image forming device according to an embodiment of the present invention;

FIG. 7 is an explanatory diagram of an exemplary hardware configuration of the post-processing device according to an embodiment of the present invention;

FIG. 8 is a functional block diagram of an example of a function executed by a CPU of the post-processing device according to an embodiment of the present invention;

FIGS. 9A and 9B are explanatory diagrams of examples of overlapping regions according to an embodiment of the present invention;

FIGS. 10A and 10B are explanatory diagrams of an example in which the overlapping region is cut into a piece larger than a printed matter and is discharged according to an embodiment of the present invention;

FIGS. 11A and 11B are explanatory diagrams of an example in which the overlapping region is cut into a mass including a plurality of printed matters and is discharged according to an embodiment of the present invention;

FIG. 12 is a flowchart of exemplary processing in a case where the printed matter and an unnecessary sheet are discharged to a card tray according to an embodiment of the present invention;

FIG. 13 is a flowchart of exemplary processing in a case where the printed matter and an unnecessary sheet are discharged to a purge tray according to an embodiment of the present invention; and

FIG. 14 is a flowchart of exemplary processing in a case where an unnecessary sheet and chips are discharged into a trash box according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. In the specification and the drawings, components having substantially the same function or structure are denoted with the same reference numerals, and the overlapped description will be omitted.

### Embodiment

<Exemplary Hardware Configuration of Image Forming Device>

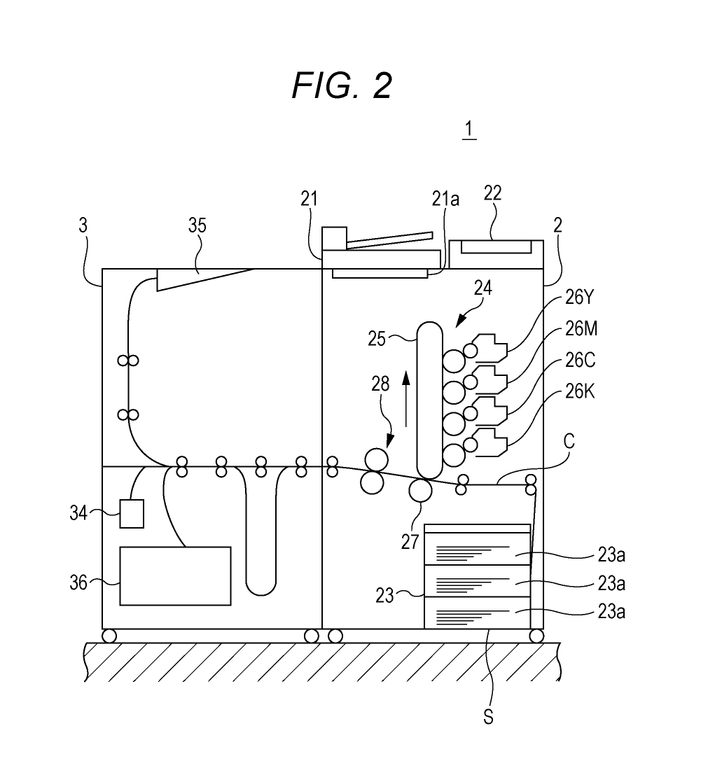

FIG. 2 is a schematic diagram of an exemplary overall configuration of an image forming system 1.

The image forming system 1 includes an image forming device 2 and a post-processing device 3.

The image forming device 2 performs image forming processing of print data received from a personal computer (PC) terminal (referred to as print processing) according to an operation instruction from an operation display 22 provided in the image forming device 2 or a print instruction from the PC terminal which is not shown transmitted via a network. Furthermore, the image forming device 2 can read characters, figures, and the like printed on a sheet S supplied from an automatic document feeder (ADF) 21 and output image data. As an image forming device 2, for example, a copier, a printer, a facsimile, and a combined apparatus combining two or more of these functions can be applied.

The image forming device 2 employs an electrophotographic method for forming an image by using static electricity and is a tandem-type color image forming device, for example, in which toner images of four colors, i.e., yellow (Y), magenta (M), cyan (C), and black (K) are superimposed. The image forming device 2 includes the automatic document feeder 21, the operation display 22, a sheet feeder 23, an image former 24, an intermediate transfer belt 25 (image carrier), a secondary transfer unit 27, and a fixer 28.

The automatic document feeder 21 automatically feeds a document when reading the document. A scanner 21a provided below the automatic document feeder 21 can read an image of a document placed on a platen glass of the image forming device 2 and an image of a document which is automatically conveyed by the automatic document feeder 21.

The operation display 22 has, for example, a function as an operation unit for instructing to start a job such as the image forming processing. The operation display 22 is configured of a touch panel including a liquid crystal display (LCD) and the like and can display an operation by a user and information. The operation display 22 has functions of both of an operation unit and a display. It is possible that the operation unit includes a mouse, a tablet, and the like and is formed separately from the display.

The sheet feeder 23 includes a plurality of sheet housings 23a which can store the different kinds of sheets S having different sizes from each other. In the sheet feeder 23, when a sheet housing 23a is selected according to an instruction from the image forming device 2, the sheet S is extracted from the sheet housing 23a and transferred to a conveyance path C.

The image former 24 includes four image forming units 26Y, 26M, 26C, and 26K used to respectively form toner images of colors, i.e., yellow, magenta, cyan, and black. The image former 24 controls operations of the image forming units 26Y, 26M, 26C, and 26K of the image former 24 and forms the toner images of Y, M, C, and K. Furthermore, the image forming device 2 includes a plurality of rollers (conveyance roller) for conveying the sheet S to the conveyance path C.

In an image forming mode, the image forming device 2 charges photoreceptors of the image forming units 26Y, 26M, 26C, and 26K, exposures the photoreceptors to erase the charge, and forms an electrostatic latent image on each photoreceptor. A developing unit attaches toners relative to the electrostatic latent image on each of the photoreceptors of yellow, magenta, cyan, and black and forms the toner images of the respective colors. Next, the toner images formed on the photoreceptors of yellow, magenta, cyan, and black are primarily transferred on a surface of the intermediate transfer belt 25 which rotates along an arrow direction in sequence.

Next, the secondary transfer unit 27 (secondary transfer roller) secondarily transfers the toner image of each color which has been primarily transferred on the intermediate transfer belt 25 on the sheet S which is fed from the sheet feeder 23 and is conveyed by a roller. By secondarily transferring the toner images of the respective colors on the intermediate transfer belt 25 on the sheet S, a color image is formed. The image forming device 2 conveys the sheet S on which the colored toner image has been formed to the fixer 28.

The fixer 28 performs fixing processing on the sheet S on which the colored toner image has been formed. The fixer 28 pressurizes and heats the conveyed sheet S to fix the transferred toner image on the sheet S. The fixer 28 includes, for example, an upper fixing roller and a lower fixing roller which are fixing members. The upper fixing roller and the lower fixing roller are arranged in a pressure contact state, and a fixing nip is formed as a pressure contact part between the upper fixing roller and the lower fixing roller.

A heater (not illustrated) is provided in the upper fixing roller. Radiation heat from the heater hears a roller part located in an outer periphery of the upper fixing roller. The sheet S is conveyed to the fixing nip so that the surface on which the toner image has been transferred by the secondary transfer unit 27 (fixing surface) faces to the upper fixing roller. The sheet S passing through the fixing nip is pressurized by the upper fixing roller and the lower fixing roller and is heated by heat of the roller part of the upper fixing roller. The sheet S on which the fixing processing has been performed by the fixer 28 is discharged to the post-processing device 3 as a print sheet or a recovery sheet. In the post-processing device 3, a card tray 34 and a purge tray 35 where a printed matter and the like are discharged are provided. In addition, in the post-processing device 3, a trash box 36, to which chips are discharged, for housing chips and unnecessary sheets (example of chip storage) is provided.

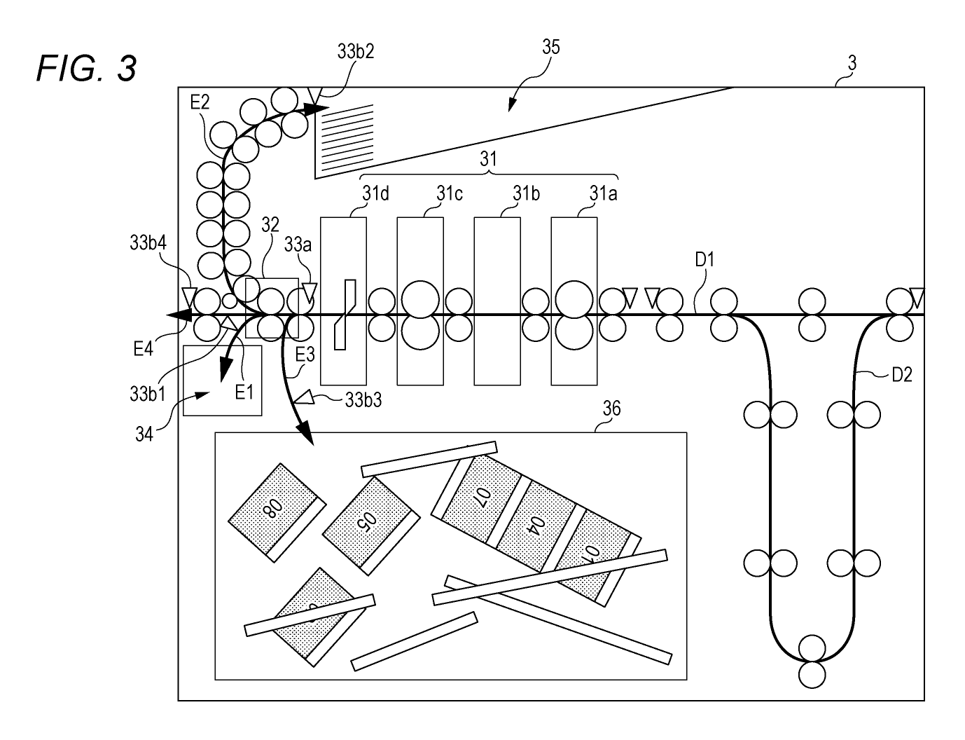

FIG. 3 is a block diagram of an exemplary inner configuration of the post-processing device 3.

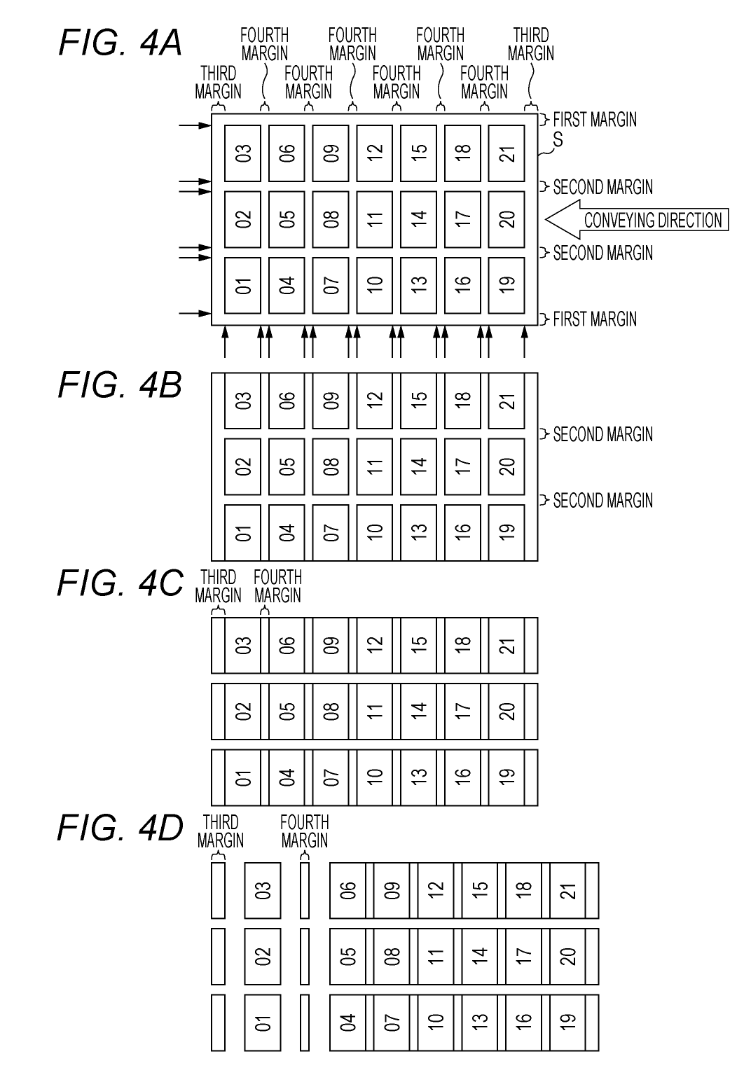

The post-processing device 3 includes post-processing modules 31a to 31d which perform predetermined post processing on the conveyed sheet S on a conveyance path D1, a discharged sheet conveyance path switch 32, a detection sensor 33a, sheet discharge sensors 33b1 to 33b4, the card tray 34, the purge tray 35, the trash box 36, the conveyance path D1, and discharged sheet conveyance paths E1 to E4. A long sheet conveyance path D2 provided in the conveyance path D1 functions as a buffer when a long sheet is conveyed. In the sheet S, as illustrated in FIGS. 4A to 4D, first to fourth margins are provided, in addition to a region where the printed matter is printed.

Furthermore, the post-processing modules 31a to 31d are removable from the post-processing device 3, and an arrangement order of the post-processing modules 31a to 31d can be appropriately changed. According to the printed matter, at least any one of the post-processing modules 31a to 31d can be removed from the post-processing device 3.

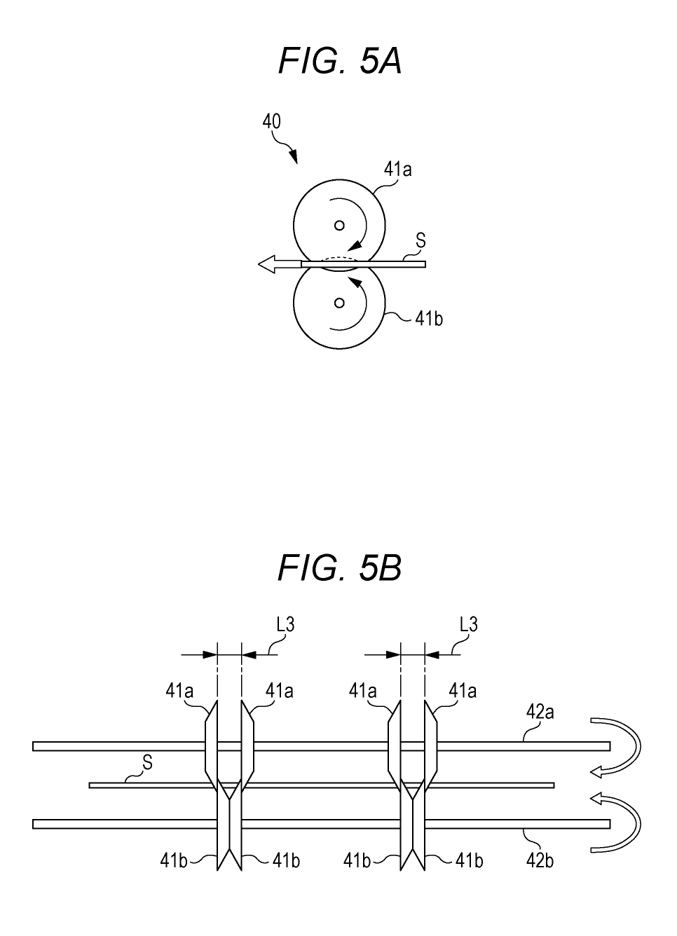

The post-processing module 31a includes a slitter 40 (refer to FIGS. 5A and 5B to be described later) which cuts the sheet S in a conveying direction (sub-scanning direction). The post-processing module 31a cuts off the first margins between the printed matter and ends of the sheet in the sheet S.

The post-processing module 31b includes, for example, a line forming unit which forms a line on the sheet S cut by the post-processing module 31a.

The post-processing module 31c includes a slitter 40 which cuts the sheet S in the conveying direction. A position where the slitter 40 of the post-processing module 31c is arranged is different from a position where the slitter 40 of the post-processing module 31a is arranged. The post-processing module 31c cuts off a second margin between the printed matters in the sheet S.

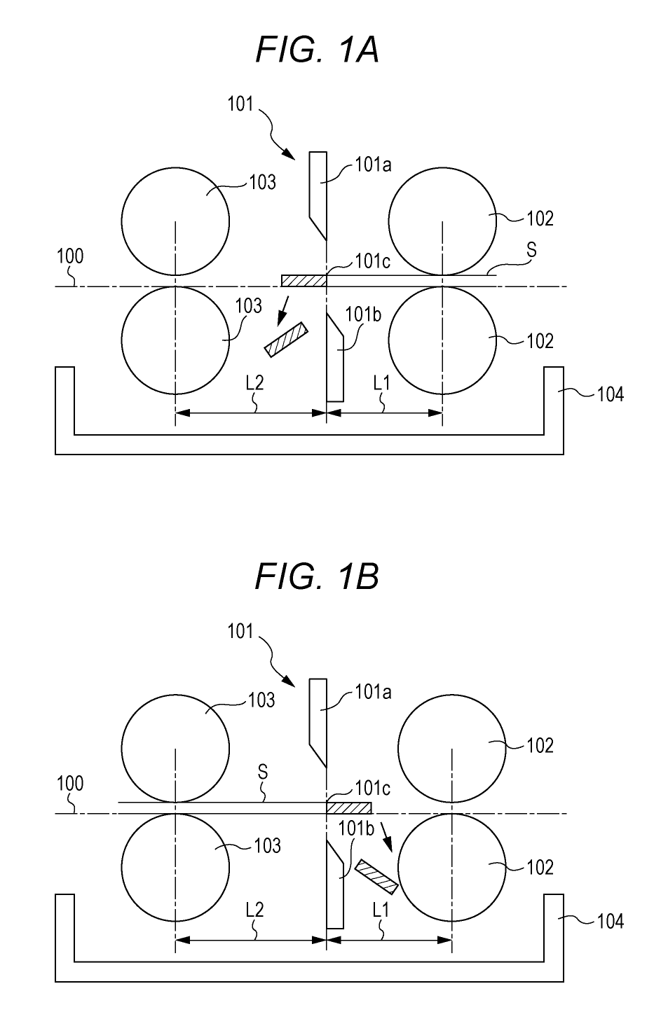

The post-processing module 31d includes the guillotine cutter 101 (refer to FIGS. 1A and 1B) which cuts the sheet S, cut by the post-processing module 31c, in a direction perpendicular to the conveying direction (main scanning direction). The sheet S cut by the post-processing module 31d in the main scanning direction is conveyed to the following parts as a printed matter, an unnecessary sheet, or chips.

In the following description, the post-processing modules 31a, 31c, and 31d which perform the cutting processing on the sheet S (print sheet or recovery sheet) are collectively referred to as a cutter 31. To cut the sheet S in a direction parallel to the conveying direction is referred to as “feed direction (FD) cutting”, and to cut the sheet S in the direction perpendicular to (intersecting with) the conveying direction is referred to as “cross direction (CD) cutting”. The post-processing modules 31a and 31c perform the FD cutting, and the post-processing module 31d performs the CD cutting.

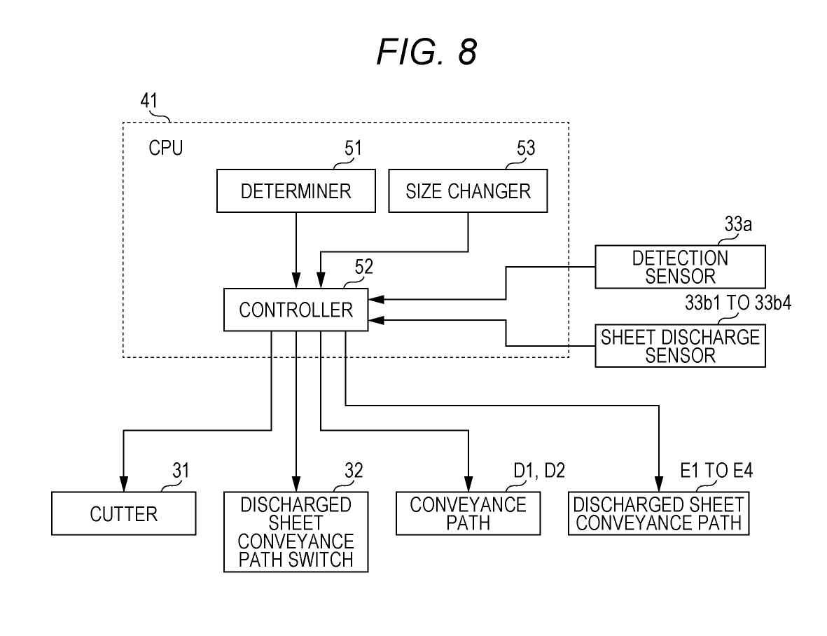

The cutting processing includes a first cutting process in which the cutter 31 FD cuts the sheet S which is a print sheet or a recovery sheet and a second cutting process in which the cutter 31 CD cuts the sheet S. Here, the cutter 31 is controlled by a controller 52 illustrated in FIG. 8 to be described later so as to perform the CD cutting after FD cutting the sheet S. The sheet S turns to any one of a printed matter, an unnecessary sheet, or chips which has been cut into a predetermined size by the cutter 31.

The discharged sheet conveyance path switch 32 switches the conveyance path to any one of the discharged sheet conveyance paths E1 to E4 according to the destination of the sheet S which has passed through the cutter 31. The discharged sheet conveyance path E1 (example of printed matter conveyer) conveys the printed matter and the unnecessary sheet to the card tray 34. The discharged sheet conveyance path E2 (example of printed matter conveyer) conveys the printed matter and the unnecessary sheet to the purge tray 35. The discharged sheet conveyance path E3 (example of chip conveyor) conveys the unnecessary sheet and chips to the trash box 36. The discharged sheet conveyance path E4 conveys the printed matter to another processing device (not illustrated) connected downstream of the post-processing device 3.

The detection sensor 33a is provided between the post-processing module 31d and the discharged sheet conveyance path switch 32 and detects a printed matter discharged from the post-processing module 31d. In a case where the detection sensor 33a cannot detect the printed matter even after elapse of predetermined time, the controller 52 determines that a jam has occurred.

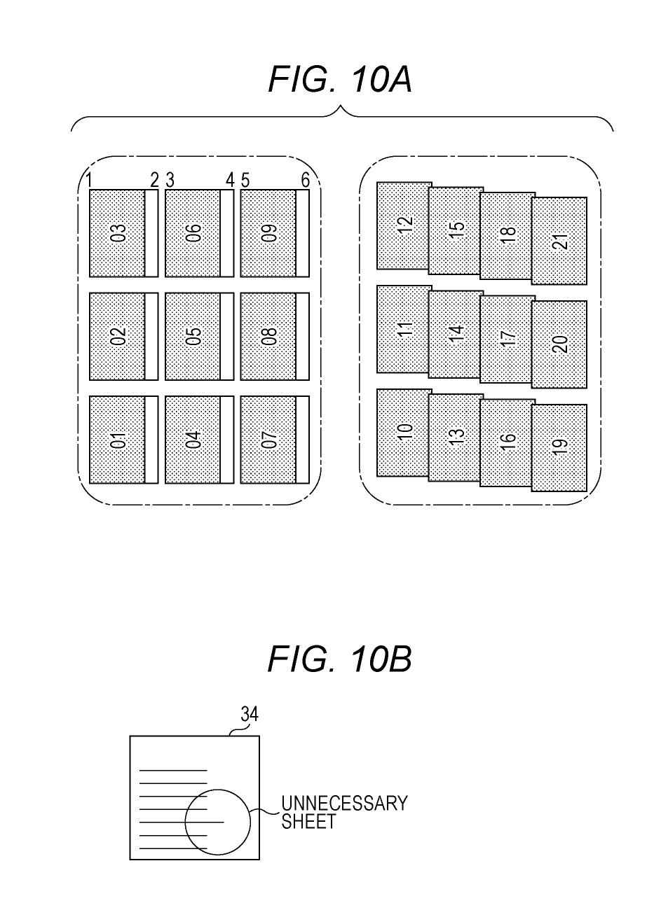

The card tray 34 is a discharge destination of the discharged sheet conveyance path E1 switched by the discharged sheet conveyance path switch 32 and is formed to have the same size as the printed matter. On the card tray 34, a printed matter conveyed by the discharged sheet conveyance path E1, a recovery sheet (unnecessary sheet) which has been cut into pieces having a size slightly larger than the printed matter in the overlapping region can be loaded. The size slightly larger than the printed matter is, for example, a size having a margin on one side of the printed matter formed by performing the FD cutting and the CD cutting on the overlapping region of the recovery sheet as illustrated in FIG. 10A to be described later. The controller 52 performs control to convey the recovery sheet which has been cut into pieces having the size slightly larger than the printed matter in the overlapping region to the card tray 34 through the discharged sheet conveyance path E1. The sheet discharge sensor 33b1 is provided in the discharged sheet conveyance path E1. Therefore, based on the detection result by the sheet discharge sensor 33b1, the controller 52 can detect whether the printed matter and the unnecessary sheet conveyed through the discharged sheet conveyance path E1 are reliably discharged to the card tray 34.

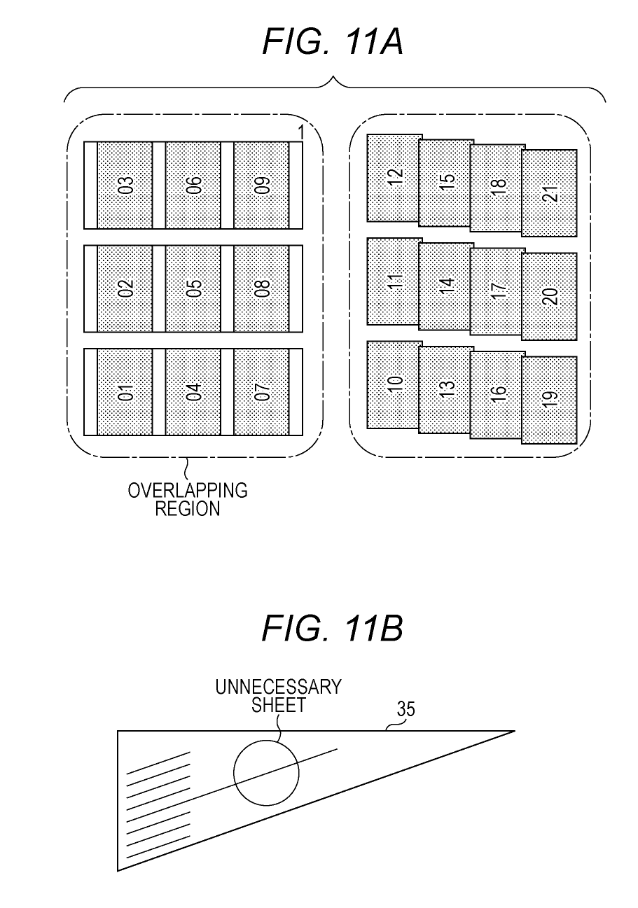

The purge tray 35 is a discharge destination of the discharged sheet conveyance path E2 switched by the discharged sheet conveyance path switch 32. Since the purge tray 35 is larger than the card tray 34, the printed matter and the recovery sheet (unnecessary sheet) which has been cut to be considerably larger than the printed matter can be loaded on the purge tray 35. The size considerably larger than the printed matter is, for example, a size having margins on both sides of the printed matter and having a shape narrow and long in the conveying direction formed by performing the FD cutting on the overlapping region of the recovery sheet as illustrated in FIG. 11A to be described later. The controller 52 performs control to convey the recovery sheet which has been cut into pieces having a size considerably larger than the printed matter in the overlapping region to the purge tray 35 through the discharged sheet conveyance path E2. The sheet discharge sensor 33b2 is provided in the discharged sheet conveyance path E2. Therefore, based on the detection result by the sheet discharge sensor 33b2, the controller 52 can detect whether the printed matter and the unnecessary sheet conveyed through the discharged sheet conveyance path E2 are reliably discharged to the purge tray 35.

The trash box 36 is a discharge destination of the discharged sheet conveyance path E3 switched by the discharged sheet conveyance path switch 32. In the trash box 36, chips of the overlapping region cut by the cutter 31, chips of the first to fourth margins, and the like are housed. The controller 52 performs control to convey the chips of the overlapping region cut by the cutter 31 and the unnecessary sheet to the trash box 36 through the discharged sheet conveyance path E3. The sheet discharge sensor 33b3 is provided in the discharged sheet conveyance path E3. Therefore, based on the detection result by the sheet discharge sensor 33b3, the controller 52 can detect whether the chips and the unnecessary sheet conveyed through the discharged sheet conveyance path E3 are reliably discharged to the trash box 36. In a case where the trash box 36 is provided immediately below the cutter 31, the cut chips and the unnecessary sheet are directly dropped into the trash box 36. Therefore, the discharged sheet conveyance path E3 is not provided, and it is not necessary to provide the sheet discharge sensor 33b3.

In a case where another processing device (not illustrated) is connected downstream of the post-processing device 3, the discharged sheet conveyance path E4 is provided to convey the printed matter to the processing device which is a discharge destination of the discharged sheet conveyance path E4 (example of printed matter conveyer) switched by the discharged sheet conveyance path switch 32. The sheet discharge sensor 33b4 is provided in the discharged sheet conveyance path E4. Therefore, based on the detection result by the sheet discharge sensor 33b4, the controller 52 can detect whether the printed matter conveyed through the discharged sheet conveyance path E4 are reliably discharged to the another processing device. However, if all the post processing has been completed by the post-processing device 3 and the printed matter can be obtained, the discharged sheet conveyance path E4 does not need to operate.

Next, the margins of the sheet S cut by the post-processing modules 31a, 31c, and 31d will be described. FIGS. 4A to 4D are explanatory diagrams of a state where the sheet S conveyed to the post-processing device 3 is cut.

The sheet S on which an image is printed on a position to be the printed matter is conveyed from right to left in FIG. 4A. Arrows illustrated on the right side surface and the lower surface of the sheet S indicate cutting directions along which the sheet S is cut by the post-processing modules 31a, 31c, and 31d (cutter 31). Furthermore, rectangular regions having numbers written therein illustrated in FIG. 4A indicate regions where business cards are printed as printed matters.

On the sheet S, the first margins which are parallel to the sub-scanning direction (conveying direction) are provided between the upper end of the sheet S and the printed matter and between the lower end of the sheet S and the printed matter. On the sheet S, the second margins which are parallel to the sub-scanning direction are provided between the printed matters in the sheet S. On the sheet S, the third margins which are parallel to the main scanning direction (direction intersecting with the conveying direction) are provided between the downstream end of the sheet S and the printed matter and between the upstream end of the sheet S and the printed matter. On the sheet S, the fourth margins which are parallel to the main scanning direction are provided between the printed matters in the sheet S.

Here, an exemplary configuration of the slitter 40 will be described with reference to FIGS. 5A and 5B.

FIGS. 5A and 5B are explanatory diagrams of an exemplary configuration of the slitter 40.

In FIG. 5A, a side view of the slitter 40 is illustrated. In FIG. 5B, a front view of the two pairs of slitters 40 is illustrated. As illustrated in FIG. 5A, the slitter 40 includes an upper slitter blade 41a arranged on the upper side of the sheet S and a lower slitter blade 41b arranged on the lower side of the sheet S. Both of the upper slitter blade 41a and the lower slitter blade 41b are rotary blades. In accordance with the conveying direction of the sheet S conveyed from right to left in FIG. 5A, the upper slitter blade 41a rotates clockwise, and the lower slitter blade 41b rotates counterclockwise.

In FIG. 5B, a front view of the two pairs of slitters 40 is illustrated.

The two pairs of upper slitter blades 41a can rotate around a common drive shaft 42a as a drive axis, and the two pairs of lower slitter blades 41b can rotate around a common drive shaft 42b as a drive axis.

One pair of slitters 40 is formed by combining two upper slitter blades 41a and two lower slitter blades 41b. The upper slitter blade 41a and the lower slitter blade 41b are arranged so that there is substantially no gap between a blade edge of the upper slitter blade 41a and a blade edge of the lower slitter blade 41b. The sheet S is cut at the position where the blade edge of the upper slitter blade 41a and the blade edge of the lower slitter blade 41b are engaged. Therefore, a width L3 between the two upper slitter blades 41a is a width for FD cutting the first margin or the second margin of the sheet S.

The description returns to FIGS. 4A to 4D.

When the sheet S is conveyed to the post-processing module 31a, the two pairs of slitters 40 provided in the post-processing module 31a FD cut the first margins of the sheet S as illustrated in FIG. 4B. Next, when the sheet S is conveyed to the post-processing module 31c, the two pairs of slitters 40 provided in the post-processing module 31c FD cut the second margins of the sheet S as illustrated in FIG. 4C. Next, when the sheet S is conveyed to the post-processing module 31d, the guillotine cutter 101 (refer to FIGS. 1A and 1B) provided in the post-processing module 31d CD cuts the third margins and the fourth margins of the sheet S as illustrated in FIG. 4D in order.

<Exemplary Hardware Configuration of Image Forming Device>

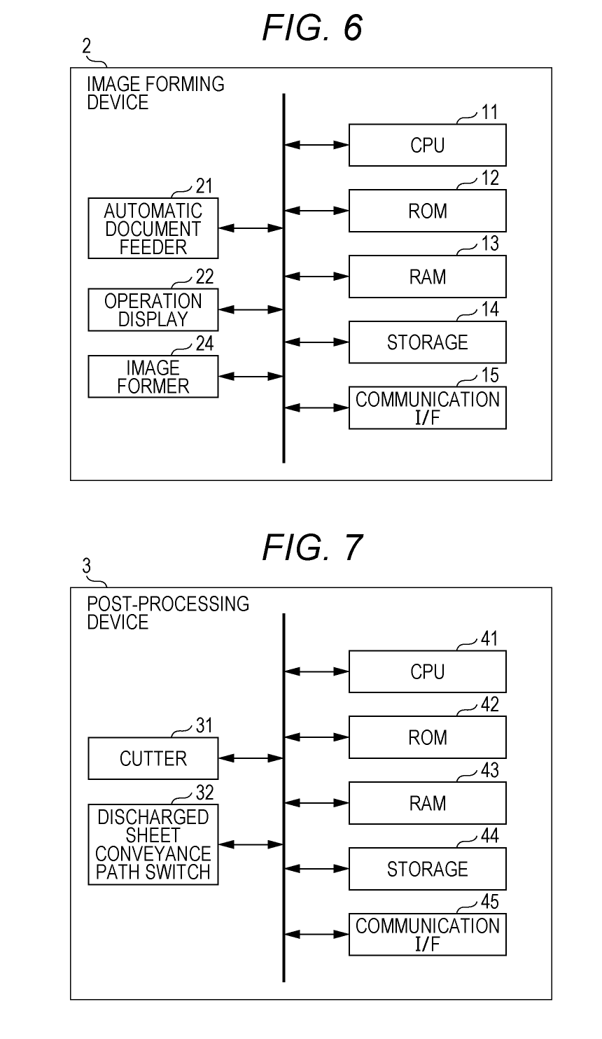

FIG. 6 is an explanatory diagram of an exemplary hardware configuration of the image forming device 2.

The image forming device 2 includes a Central Processing Unit (CPU) 11, a Read Only Memory (ROM) 12, a Random Access Memory (RAM) 13, a storage 14, and a communication interface (I/F) 15, in addition to the automatic document feeder 21, the operation display 22, and the image former 24. The parts in the image forming device 2 are connected to each other via a bus.

The CPU 11 is used as an example of a computer for controlling an operation of each part in the image forming device 2. For example, the CPU 11 controls the image forming processing (print operation) of the image former 24 based on the print instruction by the user through the operation display 22 and performs objectification processing on image data according to the present embodiment.

The ROM 12 is used as an example of a nonvolatile memory and stores a program, data, and the like necessary for an operation of the CPU 11.

The RAM 13 is used as an example of a volatile memory and temporarily stores information (data) necessary for each processing performed by the CPU 11.

The storage 14 includes, for example, a Hard Disk Drive (HDD) and stores a program for the CPU 11 to control each part, an operating system (OS), a program and data for a controller and the like. A part of the program and data stored in the storage 14 is stored in the ROM 12. The storage 14 is used as an example of a computer-readable non-transitory recording medium for storing a program executed by the CPU 11. The computer-readable non-transitory recording medium for storing the program executed by the image forming device 2 is not limited to the HDD, and for example, may be a recording medium such as a Solid State Drive (SSD), a CD-ROM, a DVD-ROM, and the like.

The communication I/F 15 includes a Network Interface Card (NIC), a modem, and the like, establishes connection with the post-processing device 3 and a PC terminal which is not illustrated, and transmits and receives various data.

<Exemplary Hardware Configuration of Post-Processing Device>

FIG. 7 is an explanatory diagram of an exemplary hardware configuration of the post-processing device 3.

The post-processing device 3 includes a CPU 41, a ROM 42, a RAM 43, a storage 44, a communication I/F 45, in addition to the cutter 31, the discharged sheet conveyance path switch 32, and the like described above. The parts in the post-processing device 3 are connected to each other via a bus.

The CPU 41 is used as an example of a computer which controls an operation of each part in the post-processing device 3. For example, the CPU 41 has a function for operating the controller 52 and the like illustrated in FIG. 8 to be described later which controls the cutting processing by the cutter 31 and selection of the conveyance path for the cut sheet S.

The ROM 42 is used as an example of a nonvolatile memory and stores a program, data, and the like necessary for an operation of the CPU 41.

The RAM 43 is used as an example of a volatile memory and temporarily stores information (data) necessary for each processing performed by the CPU 41.

The storage 44 includes, for example, a HDD and stores a program for the CPU 41 to control each part, an OS, and a program and data for a controller and the like. A part of the program and data stored in the storage 44 is stored in the ROM 42. The storage 44 is used as an example of a computer-readable non-transitory recording medium for storing a program executed by the CPU 41. The computer-readable non-transitory recording medium for storing the program executed by the post-processing device 3 is not limited to the HDD, and for example, may be a recording medium such as an SSD, a CD-ROM, a DVD-ROM, and the like.

The communication I/F 45 includes, an NIC, a modem, and the like, establishes connection with the image forming device 2, and transmits and receives various data. When the post-processing device 3 is used alone, the communication I/F 45 establishes the connection with a PC terminal which is not illustrated and transmits and receives various data.

When the post-processing device 3 is provided in inline arrangement with respect to the image forming device 2, and various functions executed by the post-processing device 3 may be executed by using the CPU 11, the ROM 12, the RAM 13, and the storage 14 of the image forming device 2. Therefore, the CPU 41, the ROM 42, the RAM 43, and the storage 44 can be removed from the post-processing device 3. On the other hand, when the post-processing device 3 is provided in offline arrangement with respect to the image forming device 2, since it is necessary for the post-processing device 3 to control itself, the CPU 41, the ROM 42, the RAM 43, and the storage 44 are required.

<Exemplary Functional Configuration of Post-Processing Device>

FIG. 8 is a functional block diagram of an example of a function executed by the CPU 41 of the post-processing device 3.

In the CPU 41, functions of a determiner 51, the controller 52, and a size changer 53 are executed.

The determiner 51 determines an overlapping region where a content of a recovery sheet on which recovery print has been performed due to an error is overlapped with a content of a printed matter obtained by the cutting processing before the error occurs in the post-processing device 3. The error is, for example, a jam occurred during the cutting processing by the cutter 31. When a jam occurs, it is necessary to stop the cutting processing.

The controller 52 makes the cutter 31 cut the overlapping region of the recovery sheet into pieces having a size larger than the printed matter. Under the control of the controller 52, the cutter 31 performs the cutting processing for cutting the print sheet or the recovery sheet into a plurality of pieces. As described above, the cutting processing is processing for cutting a sheet by a plurality of cutting processes performed by the cutter 31. The controller 52 omits, at least once, the CD cutting (second cutting process) which is performed a plurality of times at different cutting positions of the sheet S to cut the sheet S and obtain the printed matter by the cutter 31 and makes the cutter 31 perform the CD cutting. Therefore, when the recovery sheet is cut, at least one CD cutting is skipped from the normal CD cutting process.

Furthermore, in a case where a first print mode is set in which a plurality of same images is printed, the controller 52 controls the cutter 31 to cut the overlapping region in the recovery sheet into pieces having the same size as the printed matter in the overlapping region. Furthermore, in a case where a second print mode is set in which a plurality of different images is printed, the controller 52 controls the cutter 31 to cut the overlapping region in the recovery sheet into pieces having the size larger than the printed matter in the overlapping region.

The controller 52 controls the conveyance path D1 and performs control for making the recovery sheet pass through the cutter 31. According to the discharged sheet conveyance paths E1 to E4 switched by controlling the discharged sheet conveyance path switch 32, the controller 52 performs control to convey the cut sheet S to be discharged to the discharged sheet conveyance paths E1 to E4 to a discharge destination.

The controller 52 can determine whether the jam occurs based on the detection result input from the detection sensor 33a. The controller 52 can determine whether conveyance of the printed matter or the unnecessary sheet has been normally completed based on the sheet discharge results input from the sheet discharge sensors 33b1 to 33b4. When all the detection sensor 33a and the sheet discharge sensors 33b1 to 33b4 do not detect the cut sheet S within a predetermined time, the controller 52 determines that an error (jam and the like) occurs and performs control to stop an operation of each part in the post-processing device 3. In this case, the user removes the sheet S remaining in the post-processing device 3.

A timing when the detection sensor 33a detects (turns on) the sheet S varies depending on the size of the printed matter. For example, if a length of the post-processing module 31d from the cutting position 101c of the guillotine cutter 101 (refer to FIGS. 1A and 1B) to a position of the detection sensor 33a in the conveying direction is longer than a length of the printed matter in the conveying direction, the printed matter is conveyed to the position of the detection sensor 33a after the sheet S has been cut by the guillotine cutter 101. In this case, it is preferable that the detection sensor 33a detect the printed matter after the sheet S has been cut. On the other hand, if the length of the post-processing module 31d from the cutting position 101c of the guillotine cutter 101 to the position of the detection sensor 33a in the conveying direction is shorter than the length of the printed matter in the conveying direction, the sheet S is conveyed to the position of the detection sensor 33a before the sheet S is cut by the guillotine cutter 101. In this case, it is preferable that the detection sensor 33a detect the sheet S before the sheet S is cut.

In the first print mode in which the plurality of same images is printed, the size changer 53 can change the size of the pieces of the recovery sheet to be cut by the cutter 31. In a case where the first print mode is set, the controller 52 makes the cutter 31 cut the overlapping region of the recovery sheet into pieces having the size larger than the printed matter in the overlapping region based on the size changed by the size changer 53. As a result, even when the first print mode is set, the overlapping region of the recovery sheet is cut to be larger than the printed matter.

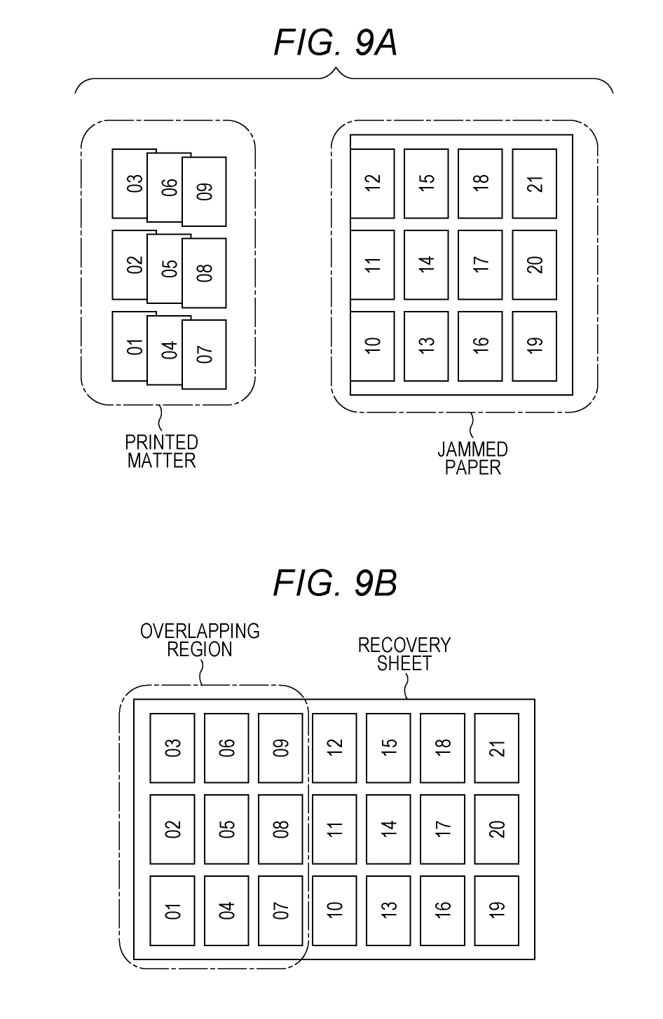

Next, a specific cutting method will be described with reference to FIGS. 9A to 11B.

FIGS. 9A and 9B are explanatory diagrams of examples of the overlapping region.

As illustrated in FIG. 9A, in a single print sheet, images of 21 business cards (distinguished by adding numbers of “01” to “21”) of three rows and seven columns are printed. It is assumed that the sheet discharge sensor 33b2 provided in the purge tray 35 detect that nine business cars (“01” to “09”) of three columns on the downstream side in the conveying direction are normally discharged to the purge tray 35. However, if an error (for example, jam) that requires to stop the cutting processing occurs when the cutter 31 performs the cutting processing, 12 business cards (“10” to “21”) subsequent to the fourth column are removed from the post-processing device 3. Then, to obtain the business cards subsequent to the fourth column which have been removed as jammed paper as the printed matter, recovery printing is required.

When the recovery printing is performed by the image forming device 2 as illustrated in FIG. 9B, the contents of the business cards (“01” to “09”) of three columns on the downstream side of the recovery sheet are the same as the contents of the business cards which have been already discharged to the purge tray 35. Therefore, the business cards of three columns on the downstream side of the recovery sheet become the overlapping region, and it is necessary to discard the overlapping region.

Here, a length of the overlapping region in the conveying direction is, for example, 55 mm×3 columns=165 mm unless the widths of the fourth margins parallel to the conveying direction are not considered. Therefore, to CD cut the overlapping region by the guillotine cutter 101 as illustrated in FIGS. 1A and 1B and discard the cut chips to the trash box 36, based on 165 mm÷10 mm=16.5, it is necessary to cut the overlapping region at least 16 times and set the length in the conveying direction to 10 mm. Therefore, to reduce the number of times of cutting by the guillotine cutter 101, the following method is used for cutting.

FIGS. 10A and 10B are explanatory diagrams of examples in which the overlapping region is cut into pieces having a size which is one size larger than the printed matter and discharged.

As illustrated in FIG. 10A, regarding the overlapping region including the three columns on the downstream side of the recovery sheet, the first margin and the second margin parallel to the conveying direction are FD cut. However, the recovery sheet is CD cut while the fourth margin perpendicular to the conveying direction remains on the downstream end of the printed matter. In the upper part of the overlapping region in FIG. 10A, the number of times of cutting “1” to “6” are written at positions where the overlapping region is CD cut. In this case, as illustrated in FIG. 10B, all the cut recovery sheets are discharged to the card tray 34. The size of the card tray 34 is set to be small so as to be provided in a limited space in the post-processing device 3. Therefore, it is desirable that the cut part of the overlapping region which can be housed in the card tray 34 be one size larger than the printed matter.

As a result of adjusting the size of the cut part of the overlapping region in this way, the recovery sheet which has been cut to be one size larger than the printed matter is housed and is loaded in the card tray 34 together with the printed matter which has been normally cut. The cut part of the overlapping region is not put into a box for shipping where the printed matter is put in. Therefore, it is possible to prevent that the cut part of the overlapping region to be discarded is erroneously put into the box for shipping and shipped. The number of times of CD cutting the overlapping region is reduced from 16 times when the sheet is CD cut into pieces with a predetermined width so as to directly drop the cut part into the trash box 36 to six times.

The cutter 31 cuts the overlapping region of the recovery sheet according to the size of the sheet which can be housed in the card tray 34 or the purge tray 35. However, the cutting position of the recovery sheet is not related to the position of the image printed on the recovery sheet. However, it is necessary to divide the cut overlapping region of the recovery sheet so that the divided region is larger than the normal printed matter.

FIGS. 11A and 11B are explanatory diagrams of an example in which the overlapping region is cut into a mass including a plurality of printed matters and is discharged.

As illustrated in FIG. 11A, in the region where the three columns on the downstream side of the recovery sheet are written, the post-processing modules 31a and 31c FD cut the first margins and the second margins. In this case, the guillotine cutter 101 CD cuts the boundary between the fourth margin provided on the downstream end of the business cards in the third column in the overlapping region (“07” to “09”) and the business cards in the fourth column in a region other than the overlapping region (“10” to “12”). In the upper part of the overlapping region in FIG. 11A, the number of times of cutting “1” is written at the position where the overlapping region is CD cut. In this way, the number of times of CD cutting the overlapping region is reduced from 16 times when the sheet is CD cut into pieces with a predetermined width so as to directly drop the cut part into the trash box 36 to once. Therefore, deterioration in productivity of the post-processing device 3 can be prevented.

As illustrated in FIG. 11B, the cut overlapping region of the recovery sheet is discharged to the purge tray 35. The size of the purge tray 35 is larger than the card tray 34, and the recovery sheet which is cut to be long in the conveying direction can be housed. Therefore, in the purge tray 35, the printed matter which has been normally cut and the overlapping region of the recovery sheet which has been cut to be long are housed and loaded. In this case, since the size of the cut overlapping region of the recovery sheet is larger than the normally cut printed matter, the user can easily remove the cut overlapping region of the recovery sheet from the purge tray 35.

Even when the unnecessary sheet has any shape illustrated in FIGS. 10A and 10B and FIGS. 11A and 11B, the sheet can be conveyed and discharged to the trash box 36 through the discharged sheet conveyance path E3 without discharging the sheet to the card tray 34 and the purge tray 35. In this case, it is preferable that the overlapping region of the recovery sheet be cut into pieces having a size which can be conveyed through the discharged sheet conveyance path E3.

The cut unnecessary sheet may be discharged into the trash box 36 by providing the trash box 36 immediately below the post-processing module 31d and without providing the discharged sheet conveyance path E3 in the post-processing device 3. For this arrangement, it is necessary to widen the length L1+L2 between the upstream conveyance roller 102 and the downstream conveyance roller 103 illustrated in FIGS. 1A and 1B. Accordingly, by CD cutting the overlapping region to be wider than a predetermined width (10 mm), the number of times of CD cutting the recovery sheet can be reduced.

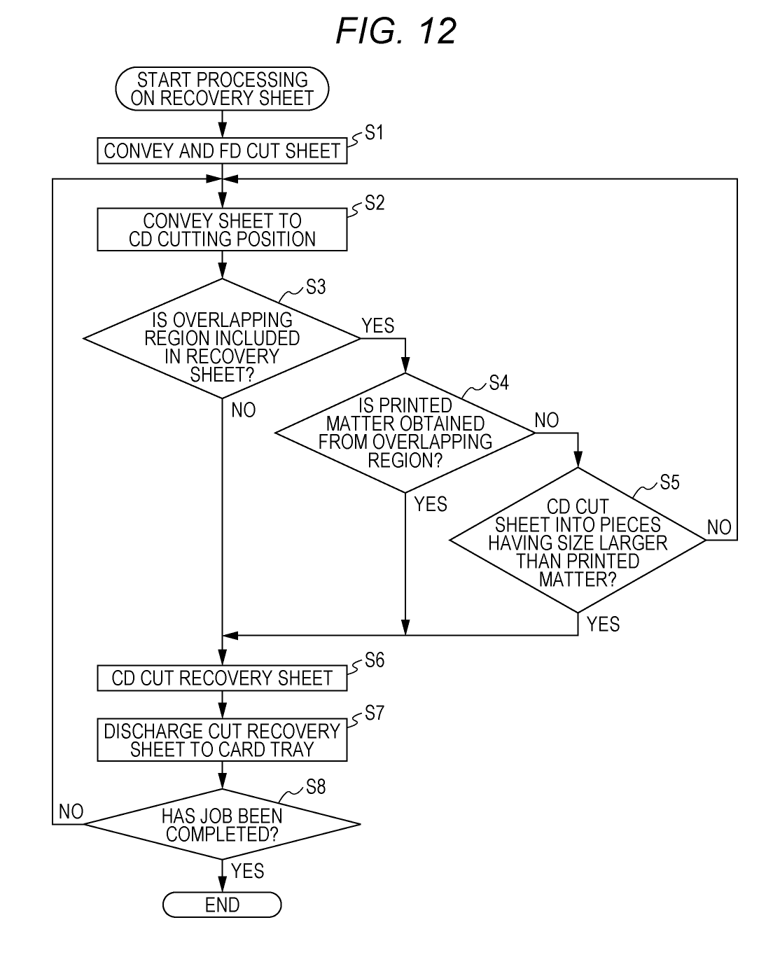

Next, three kinds of examples of the processing for cutting the recovery sheet will be described with reference to FIGS. 12 to 14. The description will start from a state where the image forming device 2 performs the recovery printing and the recovery sheet is conveyed to the post-processing device 3 due to a jam occurred in the middle of the cutting processing by the post-processing device 3 as a condition of the processing.

<Example of Processing for Discharging Sheet to Card Tray>

FIG. 12 is a flowchart of exemplary processing in a case where the printed matter and the unnecessary sheet are discharged to the card tray 34.

The post-processing device 3 starts processing on the recovery sheet. The controller 52 controls the conveyance path D1 so that the recovery sheets conveyed to cutting positions of the post-processing modules 31a and 31c are FD cut by the post-processing modules 31a and 31c (S1). With the processing in step S1, the first margins and the second margins of the recovery sheet are cut. By the control of the controller 52, the recovery sheet is conveyed to the cutting position 101c of the CD cutting performed by the guillotine cutter 101 of the post-processing module 31d (S2).

Next, the determiner 51 determines whether the conveyed recovery sheet includes a range which has been discharged as a printed matter before recovery printing, that is, an overlapping region (S3). When the determiner 51 determines that the recovery sheet includes the overlapping region (YES in S3), the controller 52 determines whether the printed matter is obtained from the overlapping region (S4).

When the controller 52 has determined that the printed matter is not obtained from the overlapping region (NO in S4), the controller 52 determines whether to make the guillotine cutter 101 CD cut the overlapping region to be one size larger than the printed matter (S5). When determining that the overlapping region is not CD cut (NO in S5), the procedure returns to step S2, and the controller 52 controls the conveyance path D1 so as to convey the recovery sheet to the position where it is determined whether to perform CD cutting next (S2).

When it is determined that the recovery sheet does not include the overlapping region in step S3 (NO in S3) or when it is determined that the printed matter is obtained from the overlapping region in step S4 (YES in S4), the controller 52 controls the post-processing module 31d to CD cut the recovery sheet (S6), and the printed matter is obtained from the recovery sheet. On the other hand, when it is determined that the overlapping region is CD cut into pieces having the one size larger than the printed matter as an unnecessary sheet in step S5 (YES in S5), the controller 52 performs control the post-processing module 31d to perform CD cutting on the overlapping region of the recovery sheet into pieces having the size which is one size larger than the printed matter in the overlapping region (S6), and an unnecessary sheet on which the fourth margins are additionally provided on the printed matter illustrated in FIG. 10A is obtained.

Next, the controller 52 controls the discharged sheet conveyance path switch 32 to switch the discharged sheet conveyance path E1, makes the discharged sheet conveyance path E1 convey the printed matter or the unnecessary sheet, and discharges the printed matter or the unnecessary sheet to the card tray 34 (S7).

Next, the controller 52 determines whether the job received from the PC terminal which is not illustrated has been completed (S8). In the job, for example, the required number of printed matters is set. When the controller 52 has determined that the job has not completed yet (NO in S8), the procedure returns to step S2, and the subsequent processing is repeated. On the other hand, when the controller 52 has determined that the job has been completed (YES in S8), the controller 52 ends the procedure.

<Example of Processing for Discharging Sheet to Purge Tray>

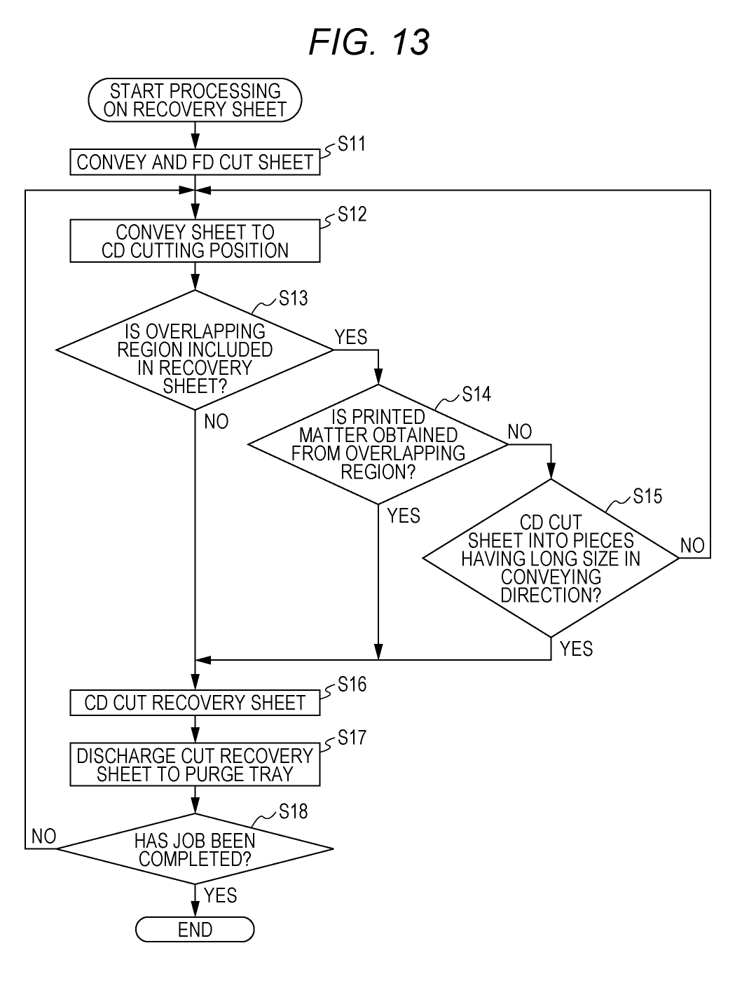

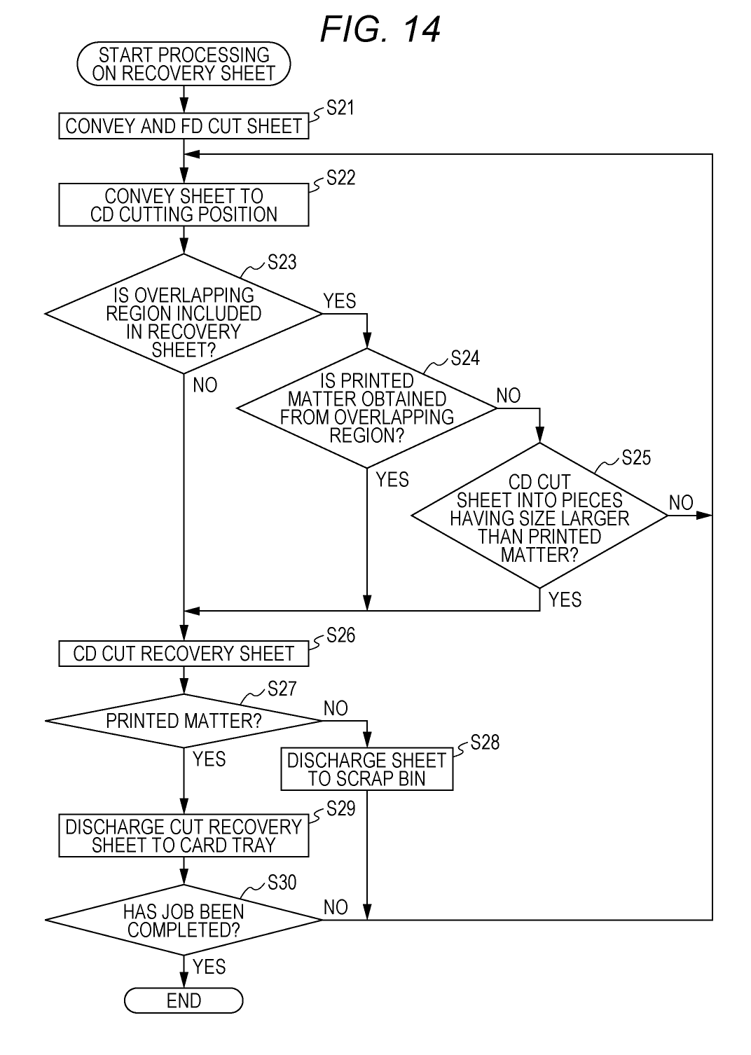

FIG. 13 is a flowchart of exemplary processing in a case where the printed matter and the unnecessary sheet are discharged to the purge tray 35. Since the processing in steps S11 to S14 in FIG. 13 is the same as processing in steps S1 to S4 in FIG. 12 described above, the detailed description thereof will be omitted.

When it is determined that the printed matter is not obtained from the overlapping region in step S14 (NO in S14), the controller 52 controls the post-processing module 31d to determine whether to make the guillotine cutter 101 CD cut the overlapping region into pieces having a narrow and long size in the conveying direction (S15). When it has been determined that the overlapping region is not CD cut (NO in S15), CD cutting is not performed on the recovery sheet, and the procedure proceeds to step S17.

When it is determined in step S13 that the range discharged as a printed matter before the recovery printing is not included (NO in S13), in a case where it is determined in step S14 that the overlapping region is assumed as the printed matter (YES in S14), the controller 52 controls the post-processing module 31d to CD cut the recovery sheet (S16), and the printed matter is obtained from the recovery sheet. On the other hand, when it is determined in step S15 that the overlapping region is CD cut into pieces having a size narrow and long in the conveying direction (YES in S15), the controller 52 controls the post-processing module 31d to CD cut the boundary between the overlapping region of the recovery sheet and the region other than the overlapping region (S16), and the unnecessary sheet illustrated in FIG. 11A is obtained.

Next, the controller 52 controls the discharged sheet conveyance path switch 32 to switch the discharged sheet conveyance path E2, makes the discharged sheet conveyance path E2 convey the printed matter or the unnecessary sheet, and discharges the printed matter or the unnecessary sheet to the purge tray 35 (S17).

Next, the controller 52 determines whether the job received from the PC terminal which is not illustrated has been completed (S18). When the controller 52 has determined that the job has not completed yet (NO in S18), the procedure returns to step S12, and the subsequent processing is repeated. On the other hand, when the controller 52 has determined that the job has been completed (YES in S18), the controller 52 ends the procedure.

<Example of Processing for Discharging Unnecessary Paper to Trash Box>

FIG. 14 is a flowchart of exemplary processing in a case where an unnecessary sheet and chips are discharged to the trash box 36. Since the processing in steps S21 to S26 in FIG. 14 is the same as processing in steps S1 to S6 in FIG. 12 described above, the detailed description thereof will be omitted. In step S25 of this processing, it is assumed that the size of the CD cut overlapping region of the recovery sheet be a size larger than the printed matter, that is, one size larger than the printed matter (refer to FIG. 10A). Furthermore, in this processing, the cut overlapping region of the recovery sheet is di to the trash box 36 as an unnecessary sheet.

After the recovery sheet has been CD cut in step S26, the controller 52 determines whether the cut recovery sheet is a printed matter (S27). When determining that the cut recovery sheet is not the printed matter (NO in S27), the controller 52 assumes the cut recovery sheet as an unnecessary sheet. Then, the controller 52 controls the discharged sheet conveyance path switch 32 to switch the conveyance path to the discharged sheet conveyance path E3 so that the unnecessary sheet is conveyed through the discharged sheet conveyance path E3. As a result, the controller 52 cam make the discharged sheet conveyance path E3 convey the unnecessary sheet and discharge the unnecessary sheet to the trash box 36 (S28). Thereafter, the procedure returns to step S22.

On the other hand, when it is determined in step S27 that the cut recovery sheet is a printed matter (YES in S27), the controller 52 controls the discharged sheet conveyance path switch 32 to switch the conveyance path to the discharged sheet conveyance path E1 so that the discharged sheet conveyance path E1 or E2 conveys the printed matter. As a result, the printed matter is discharged to the card tray 34 (S29). By controlling the discharged sheet conveyance path switch 32 to switch the conveyance path to the discharged sheet conveyance path E2, the controller 52 may discharge the printed matter to the purge tray 35.

Next, the controller 52 determines whether the job received from the PC terminal which is not illustrated has been completed (S30). When the controller 52 has determined that the job has not completed yet (NO in S30), the procedure returns to step S22, and the subsequent processing is repeated. On the other hand, when the controller 52 has determined that the job has been completed (YES in S30), the controller 52 ends the procedure.

In step S25, the size of the overlapping region of the recovery sheet to be CD cut may be a narrow and long size in the conveying direction (refer to FIG. 11A). Even in this case, the cut overlapping region of the recovery sheet is discharged to the trash box 36 as an unnecessary sheet.

In the post-processing device 3 according to an embodiment described above, when the overlapping region of the recovery sheet is CD cut, a cutting width of the recovery sheet in the conveying direction is set to be longer than the length of the printed matter in the conveying direction. Therefore, in comparison with a case where the overlapping region of the recovery sheet is CD cut so that the width of the cut region is shorter than a predetermined width obtained from the length between the upstream conveyance roller 102 and the downstream conveyance roller 103 (for example, 10 mm), the number of times cutting can be reduced, and deterioration in productivity of the post-processing device 3 can be prevented.

The size of the cut overlapping region of the recovery sheet is larger than the size of the original printed matter. Therefore, even when the cut overlapping region of the recovery sheet is discharged to the card tray 34 or the purge tray 35 similarly to the printed matter as an unnecessary sheet, the size of the unnecessary sheet is different from the printed matters loaded on each tray. Therefore, the user can save the trouble of looking for the unnecessary sheet from the card tray 34 or the purge tray 35. Furthermore, the overlapping region which is cut to be larger than the printed matter is output to the card tray 34 or the purge tray 35 where the printed matter is output. Since the size of the overlapping region which is cut to be larger than the printed matter is different from the size of the printed matter, the user can easily find the unnecessary sheet and can immediately remove the unnecessary sheet from the printed matters.

In addition, after being FD cut by the post-processing modules 31a and 31c, the overlapping region of the recovery sheet is CD cut by the post-processing module 31d By specifying the order of the cutting processes, the number of conveying rollers arranged in the post-processing modules 31a to 31d can be reduced, and the post-processing device 3 can be easily maintained.

Since the controller 52 can switch methods of cutting the overlapping region of the recovery sheet according to the print mode, this enhances the convenience of the user. For example, in a variable printed matter on which contents different for each sheet are printed, such as addresses of post cards, the overlapping region is not required in the recovery sheet. Therefore, the overlapping region of the recovery sheet is cut into pieces having a size, which does not become a printed matter, by the post-processing module 31d and is discharged to the trash box 36. On the other hand, in a case of a printed matter on which the same contents are printed on the plurality of sheets such as a business cards and a card, the overlapping region of the recovery sheet is cut and can be obtained as a printed matter. Therefore, the overlapping region of the recovery sheet is cut into pieces having a size to be the printed matter by the post-processing module 31d and is discharged to the card tray 34 or the purge tray 35.

The method of cutting the overlapping region of the recovery sheet may be set based on a method which has been optionally selected by the user.

Furthermore, by providing the discharged sheet conveyance path E3 for conveying the overlapping region to the trash box 36, chips, unnecessary sheets, and the like are automatically discharged to the trash box 36. Therefore, the user does not need to remove the overlapping region from the card tray 34 or the purge tray 35.

### Modification

In a case where the post-processing device 3 is configured as an in-line system connected to the image forming device 2, the post-processing device 3 notifies the image forming device 2 of the region obtained as a printed matter before a jam occurs. The image forming device 2 may select processing for printing an image on a region other than the overlapping region as the recovery printing without printing the overlapping region overlapped with the printed matter obtained before the jam occurs Accordingly, it is not necessary for the image forming device 2 to consume unnecessary toner used to form an image on the overlapping region to be discarded as an unnecessary sheet. For example, at the time of recovery printing, it is not necessary to print the business cards of three columns on the downstream side of the recovery sheet illustrated in FIG. 9B. If the overlapping region is not printed in this way, for example, in a case of the variable printing, leakage of personal information can be prevented.

The sheet which can be cut by the post-processing device 3 is not limited to the sheet S. For example, the post-processing device 3 may cut a resin sheet on which an image has been formed by the image forming device 2.

Although embodiments of the present invention have been described and illustrated in detail, the disclosed embodiments are made for purposes of illustration and example only and not limitation. The scope of the present invention should be interpreted by terms of the appended claims, and it goes without saying that various application examples and modifications can be made without departing from the scope of the present invention described in the claims.

For example, the embodiment is a detailed and specific description of the structures of the device and the system for easy description of the present invention and is not limited to those having all the configurations described above. A part of the configuration of the embodiment described here can be replaced with the configuration of the other embodiment, and in addition, the configuration of the other embodiment can be added to a configuration of an embodiment. A part of the components of the embodiment can be deleted from and replaced with the other components, and the other component can be added to the component of the embodiment.

The control lines and the information lines which are considered to be necessary for the description are illustrated, and not all the control lines and the information lines required for a product are not necessarily illustrated. In practice, it can be considered that almost all the parts are mutually connected.

What is claimed is:

1. A post-processing device comprising:
a cutter that performs cutting processing for dividing a printed sheet into a plurality of pieces; and
a hardware processor that
determines an overlapping region where a content of a recovery-printed sheet on which recovery printing has been performed due to an error which causes the cutting processing to be stopped during the cutting processing by the cutter is overlapped with a content of a printed matter obtained by the cutting processing before the error occurs, and
makes the cutter cut the overlapping region of the recovery-printed sheet into pieces larger than the printed matter.

2. The post-processing device according to claim 1, wherein
the cutting processing includes a first cutting process in which the cutter cuts the sheet in a direction parallel to a conveying direction of the sheet and a second cutting process in which the cutter cuts the sheet in a direction intersecting with the conveying direction of the sheet, and
the hardware processor omits, at least once, the second cutting process which is performed a plurality of times at different cutting positions to cut the sheet to obtain the printed matter by the cutter and makes the cutter perform the second cutting process.

3. The post-processing device according to claim 1, wherein
the hardware processor controls the cutter to perform the second cutting process after performing the first cutting process on the sheet.

4. The post-processing device according to claim 1, wherein
the hardware processor makes the cutter cut the overlapping region into pieces having the same size as the printed matter in the overlapping region in a case where a first print mode is set in which a plurality of same images is printed on the sheet and makes the cutter cut the overlapping region to be larger than the printed matter in the overlapping region in a case where a second print mode is set in which a plurality of different images is printed on the sheet.

5. The post-processing device according to claim 4, wherein
the hardware processor is further capable of changing a size of the piece of the sheet to be cut by the cutter in the first print mode, and
makes a change to make the cutter cut the overlapping region of the recovery-printed sheet to be larger than the printed matter in the overlapping region in a case where the first print mode is set.

6. The post-processing device according to claim 1, further comprising:
a printed matter conveyer that conveys the printed matter to a printed matter storage where the printed matter is stored, wherein
the hardware processor performs control to convey the recovery-printed sheet which has been cut to be larger than the printed matter in the overlapping region to the printed matter storage by the printed matter conveyer.

7. The post-processing device according to claim 1, further comprising:
a chip storage that stores chips of the overlapping region cut by the cutter.

8. The post-processing device according to claim 7, further comprising:
a chip conveyer that conveys the chips from the cutter to the chip storage.

9. An image forming system including an image forming device which outputs a printed sheet on which an image to be a printed matter is printed and a post-processing device which is arranged on a downstream side of the image forming device and receives the printed sheet from the image forming device, the system comprising:
a cutter that performs cutting processing for dividing the printed sheet into a plurality of pieces; and
a hardware processor that
determines an overlapping region where a content of a recovery-printed sheet on which recovery printing has been performed due to an error which causes the cutting processing to be stopped during the cutting processing by the cutter is overlapped with a content of a printed matter obtained by the cutting processing before the error occurs, and
makes the cutter cut the overlapping region of the recovery-printed sheet into pieces larger than the printed matter.

10. The image forming system according to claim 9, wherein
the image forming device selects processing for printing the image in a region other than the overlapping region without printing the overlapping region overlapped with the printed matter as the recovery printing.
